(19) United States
(12) Patent Application Publication
(10) Pub. No.: US 2024/0307801 A1
(43) Pub. Date: Sep. 19, 2024

(54) FILTER ELEMENT AND FILTER SYSTEM HAVING RADIAL FLOW BYPASS CHANNELS IN THE END PLATE

(71) Applicant: MANN+HUMMEL GmbH, Ludwigsburg (DE)

(72) Inventors: Christopher BAUMANN, Kalamazoo, MI (US); Hermanth Kumar VENKATESH NAYAK, Mysore (IN)

(21) Appl. No.: 18/183,342

(22) Filed: Mar. 14, 2023

(51) Int. Cl. B01D 35/147; B01D 29/21; B01D 46/00; B01D 46/24; B01D 46/52

(52) U.S. Cl. CPC B01D 35/1475; B01D 29/21; B01D 46/0087; B01D 46/2414; B01D 46/521; B01D 2201/12; B01D 2201/167; B01D 2201/291

(57) ABSTRACT

A filter element is disclosed having an annular filter medium surrounding an open interior, and an end plate secured on an axial end face of the filter medium, the end plate having radially extending crossflow channels formed in the interior of the end plate with flow controlled by a bypass valve. A filter housing is also disclosed cooperating with the filter element to provide a fluid drainage arrangement.

### TECHNICAL FIELD

The present invention relates to filter systems and filter element, in which the filter element includes an end plate having radially extending fluid crossflow channels integrated into the end plate in communication with a bypass valve, the end plate crossflow channels providing fluid bypasss radially through an interior of the end plate.

### BACKGROUND OF THE INVENTION

In view of the technical field disclosed above, at least the following background art of a filter element with a bypass valve is known.

US 2014/0083951 discloses a filter cartridge element having a return valve arranged in an interior of the filter element, having a closure element closing off the valve seat and an opening position in which the closure element enables the passage of fluid through the valve seat, a return member distinct from the filter cartridge, is configured to act by biasing the closure element into the closed position.

US 2014/0262995 discloses a valve assembly of a filter element having a valve plunger with a valve stem and a valve plate connected to the valve stem and designed to close a valve opening. The valve assembly has a spring element with a spring section for generating a restoring force and a holding section for mechanically coupling the spring element to the coupling section of the valve plunger. The valve stem is enclosed at least partially by the spring section. The holding section and the coupling section engage each other such that the spring section generates a restoring force along a center axis of the valve assembly that forces the valve plate against a rim of the valve opening.

US 2016/0332101 discloses a filter cartridge including a filter media, a first end plate including a bypass flow opening, a second end plate, and a spring tube bypass assembly. The spring tube bypass assembly includes a first center tube and a spring. The spring tube bypass assembly is configured such that fluid flow through the bypass flow opening is blocked when a fluid pressure acting on the filter cartridge is below a predetermined pressure and fluid may flow through the bypass filter opening when the fluid pressure acting on the filter cartridge exceeds the predetermined pressure.

Respectfully these and none of the prior art appears to teach a filter element having radially extending fluid crossflow channels formed into an interior of the end plate.

### SUMMARY OF THE INVENTION

An object of the invention is to provide a filter element is to provide a filter element having radially extending crossflow channels extending radially through an interior of the material of the filter element end plate such that fluid can be bypassed from the inflow side of the filter element to the outflow side of the filter element through end plate crossflow channels without flowing through the filter medium. This is desirable when it becomes necessary to bypass a portion of the fluid to be filtered around the filter medium, for example, when flow is obstructed in the filter medium and/or when a pre-defined pressure drop limit is exceeded.

In aspects of the invention, a filter for filtering a gaseous or liquid fluid is disclosed, having an annular filter medium, surrounding a substantially open interior of the filter medium and defining a longitudinal axis of the annular filter medium. The filter medium has an inflow face preferably at a radially outer side of the annular filter medium receiving unfiltered fluid to be filtered, and an outflow face preferably at a radially inner side of the annular filter medium discharging filter fluid, the outflow face surrounding the substantially open interior.

In aspects of the invention, the end plate is arranged on and covering a first axial end filter element, preferably this is a lower end of the filter element, relative to the direction of gravity. The end plate includes a central flow opening extending axially through the end plate and opening into the substantially open interior of the filter element. At least one radial crossflow channel is provided extending radially through an interior of the material of the end plate from a radially outer side of the end plate and preferably opening into the central flow opening of the end plate. The at least one crossflow channel is positioned and configured to bypass fluid flow through the interior of the material of the end plate from the radially outer side of the end plate into the central flow opening of the end plate where the bypass flow may be controlled by a bypass valve, thereby bypassing fluid flow around the annular filter medium when necessary.

In aspects of the invention, an inlet opening of the at least one radial crossflow channel is arranged at the radially outer side of the end plate and is in fluid communication with the unfiltered fluid to be filtered. An outlet opening of the at least one radial crossflow channel is arranged at the radially inner side of the end plate proximate to or facing the central flow opening of the end plate.

In some aspects of the invention, the filter element further includes a bypass valve assembly arranged in the substantially open interior of the filter element and responsive to changes in fluid pressure drop through the annular filter medium to open or close off bypass flow from the at least one radial crossflow channel of the end plate. The bypass valve assembly includes a valve body arranged to move axially from a first position where the valve body closes off the central flow opening of the end plate, to a second position where the valve body move away from the central flow opening, enabling bypass fluid to flow from the end plate radial cross flow channels and enter the substantially open interior. The valve body further includes a valve housing and a valve spring acting against the valve housing and the valve body, applying a closing force on the valve body to hold the valve body in the first position. In operation, when the fluid pressure drop of the filter element exceeds a predefined limit, the closing force of the spring is overcome by the fluid pressure and the valve body moves freely to the second position, thereby enabling bypass fluid to flow from the end plate radial cross flow channels and enter the substantially open interior of the filter element.

In aspects of the invention, the inlet opening of the at least one radial crossflow channel is arranged at the radially outer side of the end plate and is in fluid communication with the unfiltered fluid to be filtered. The outlet opening of the at least one radial crossflow channel is arranged at the radially inner side of the end plate proximate to the central flow opening and arranged to be controlled by the bypass valve assembly.

In some aspects of the invention, the bypass valve assembly is secured onto or detachably secured onto an interior face of the end plate, preferably arranged within the substantially open interior and positioned to block or enable flow through the central opening of the end plate according to pressure or flow conditions.

In some aspects of the invention, the valve seat is formed by the end plate about an outer circumference of the central flow opening of the end plate such that the valve body closes against the valve seat when in the first position, closing off flow through the central opening.

In aspects of the invention, the valve body or the valve seat includes an elastomeric seal arranged to seal the valve body against the valve seat when the first position.

In some aspects of the invention, the valve housing includes at least one axially extending groove formed in a radially outer side of the valve housing, the at least one axially extending groove forming a portion of a fluid flow path for bypass fluid to flow from the end plate radial cross flow channels, through the at least one axially extending groove and the enter the substantially open interior of the filter element.

In some aspects of the invention, a drain plug member is arranged on and projecting axially outwardly away from an axially outer side of the end plate. Preferably, at least one elastomeric seal is arranged on the drain plug member and adapted to seal against and close off a housing drain opening of the filter housing when the filter element is installed state in the filter housing, and to open the drain opening when the filter element is removed from the installed state.

In some aspects of the invention, the end plate has an upper annular wall, a lower annular wall, and a plurality of radially extending bypass channel separation walls arranged between the upper annular wall and the lower annular wall of the end plate. The plurality of radially extending bypass channel separation walls each connected to at least one of the annular walls of the end plate. The upper annular wall, the lower annular wall and the plurality of radially extending bypass channel separation walls cooperate to define and form the at least one radial crossflow channel within the interior of the end plate and wherein the upper annular wall and the lower annular wall are assembled together to form the end plate.

In further aspects of the invention, the end plate further includes a support tube formed together with the end plate in one piece at a same time as a single unitary component, the support tube having a plurality of flow openings. The support tube is arranged in the substantially open interior of the filter element and positioned to support the annular filter medium at the outflow face.

In preferred aspects of the invention, the end plate is completely formed in one piece in its entirety, preferably of a plastic material by injection molding, all formed together at a same time, as a single unitary one-piece component.

In further aspects of the invention, a filter system is disclosed configured for filtering a gaseous or liquid fluid. The filter system includes a filter housing having an interior chamber configured to receive the filter element discussed in various aspects discusses above, such that when the filter element is installed in the filter housing, unfiltered gaseous or liquid fluid enters the filter element at the inflow face at a radially outer side of the annular filter medium. Filtered gaseous or liquid fluid exits the filter element at the outflow face at the at a radially inner side of the annular filter medium, and into the substantially open interior of the annular filter medium. Wherein the at least one radial crossflow channel of the end plate form at least a portion of a flow path operable for bypassing the gaseous or liquid fluid around the filter medium of the filter element. Wherein the inlet opening of the at least one radial crossflow channel at the radially outer side of the end plate is in fluid communication with the gaseous or liquid fluid and wherein the outlet opening of the at least one radial crossflow channel at the radially inner side of the end plate is arranged facing towards the central flow opening.

In additional aspects of the invention, a bypass valve assembly is arranged in the substantially open interior of the filter element and is responsive to changes in fluid pressure drop through the annular filter medium so as to open or close off bypass flow from the at least one radial crossflow channel of the end plate. The bypass valve assembly including: a valve body arranged to move axially from a first position where the valve body closes off the central flow opening of the end plate, to a second position where the valve body moves away from the central flow opening, enabling bypass fluid to flow from the end plate radial cross flow channels and enter the substantially open interior. A valve housing and a valve spring act against the valve housing and the valve body, applying a closing force onto the valve body to hold the valve body in the first position, wherein when the fluid pressure drop exceeds a predefined limit, the spring closing force is overcome, and the valve body moves to the second position.

In further aspects of the invention, the valve housing includes at least one axially extending groove formed in a radially outer side of the valve housing, the at least one axially extending groove forming a fluid flow path for fluid to flow from the end plate radial cross flow channels, flowing then around the outer side of the valve housing and entering the substantially open interior of the filter element.

In further aspects of the filter system of the invention, the filter housing further includes a housing drain opening formed as a depression in a bottom wall of the filter housing, wherein the at least one elastomeric seal arranged on the drain plug member seals against walls of the housing drain opening depression and closes off a housing drain opening when the filter element is installed state in a filter housing, and opens the drain opening when the filter element is removed from the installed state.

In further aspects of the filter system of the invention, the drain opening depression is an annular groove formed in the bottom wall of the filter housing and surrounding the longitudinal axis, and the drain plug member is annular, configured to seal annularly between the end plate and a bottom wall of the housing so as to separate the inflow side of the filter element from the outflow side, preventing fluid from bypassing the filter medium except through the crossflow channels of the end plate.

Further possible implementations of the invention comprise also combinations, not explicitly mentioned, of features or method steps disclosed above or in the following about the embodiments. In this context, a person of skill in the art will also add individual aspects as improvements or supplements to the respective basic form of the disclosed inventive filter element and filter system.

Further configurations of the invention are subject matter of the dependent claims as well as of the embodiments of the invention described in the following. In the following, the invention will be explained in more detail with the aid of embodiments with reference to the attached figures.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presented as preferred; however, the invention is not limited to the precise arrangement shown in the drawings, but is to be further understood from the disclosure of the specification and the claims.

FIG. 1 depicts a schematic elevational view of a filter housing of a filter system, consistent with the present inventive disclosure;

FIG. 2. depicts a schematic quarter section perspective view of a lower portion of the filter system of FIG. 1, the section illustrating inventive internal details of the filter system presented herein, consistent with the present inventive disclosure;

FIG. 3 depicts an enlarged quarter section perspective view showing inventive internal details of the bypass valve shown in FIG. 2, consistent with the present inventive disclosure;

FIG. 4 depicts an enlarged quarter section perspective view showing inventive internal details of the filter element end plate of FIGS. 1 and 2, formed in one piece, including the radial extending bypass channels formed within the filter element end plate, consistent with the present inventive disclosure; and

FIG. 5 depicts in partial quarter section an aspect of the invention in which a filter element support tube is formed in one piece with the filter element end disk. In this particular aspect of the invention, the filter element end disk is formed in two pieces: a plate member with channel walls formed thereon, which is connected to an annular plate similar to the upper plate of FIG. 4, consistent with the present inventive disclosure.

Skilled artisans will appreciate that elements in the figures are illustrated for clear presentation and to be enabling to the reader and have not necessarily been drawn to scale. For example, the dimensions of some of the elements in the figures may be exaggerated relative to other elements to help to improve understanding of embodiments of the present invention, or disclosed portions are omitted in some views to better show critical elements of the invention.

### DETAILED DESCRIPTION

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

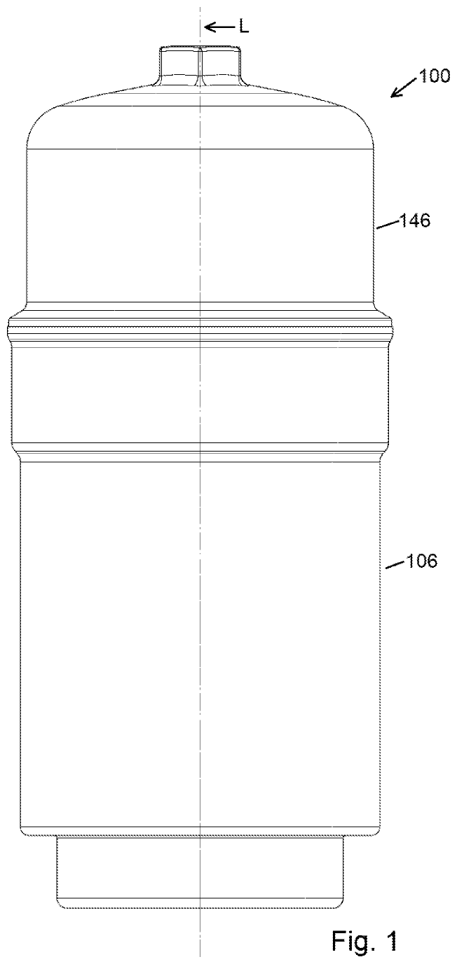

FIG. 1 depicts a schematic side elevational view of a filter housing (106+146) of a filter system 100, consistent with the present inventive disclosure.

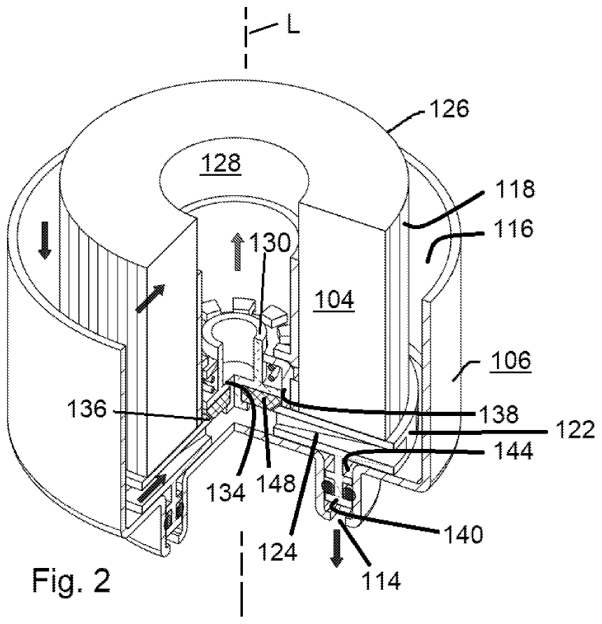

FIG. 2. depicts an internal view of the lower portion of the filter system 100 of FIG. 1, illustrated in a schematic quarter section side perspective view . A lower portion of the radial outer wall of the filter housing 106 is shown, having an interior chamber 116 into which an annular filter element 126 is received. The filter element 126 includes a filter medium 104, which preferably is arranged to form an annular filter medium 104 having a substantially open interior. We define “substantially open”, as used herein, in that the interior of the annular filter medium 104 may have other elements, for one example, a support tube 108, arranged therein, however the substantially interior surrounded by the filter medium 104 provides open space which is available for fluid flow therein, therefore substantially open by definition herein.

The filter medium filter media 104 is preferably pleated into a plurality of pleats surrounding the longitudinal axis L, as the pleating provides an substantially increased available filtration area in the filter medium 104, thereby increasing filter life and decreasing pressure drop across the filter medium 104 due to fluid flow through the filter medium 104.

An end plate 122 is connected to lower axial end of the annular filter medium 104, to form the filter element 102. The filter element 102 is configured to filter a gaseous or liquid fluid and is configured for radial flow through the filter medium 104, preferably from the radially outer side or inflow side 126 of the filter element 102, flowing through the filter medium 104 to exit at the radially inner side or outflow side 128 of the filter medium 105.

The annular filter medium 104 surrounds the substantially open interior, defining a longitudinal axis L of the annular filter medium 104 and the filter element 102. The annular filter medium includes an inflow face 126 at a radially outer side of the annular filter medium 104 receiving unfiltered fluid to be filtered from the annular space between the annular filter medium 104 and the radial outer wall of the filter housing 106. The filter medium 104 has an outflow face 128 at a radially inner side of the annular filter medium 104 discharging filtered fluid. The outflow face 128 surrounds the substantially open interior.

The end plate 122 arranged on the lower axial end face of the annular filter medium 104 is disc-shaped, annular and has a central flow opening 150 extending axially through the plate and opening into the substantially open interior. At least one radial crossflow channel 124 extends radially through an interior of the end plate 122, extending from a radially outer side of the end plate 122, through the interior of the end plate 122 and opening into the central flow opening 150 of the end plate 122. The at least one crossflow channel 124 is configured to bypass fluid flow radially through an interior of the end plate 122, thereby bypassing the annular filter medium 104. In general, the bypass through the at least one radial crossflow channel 124 is may be enabled when fluid flow through the filter medium results in a pressure drop across the filter element 102 that exceed a predefined upper limit, as will be discussed further at a later point herein.

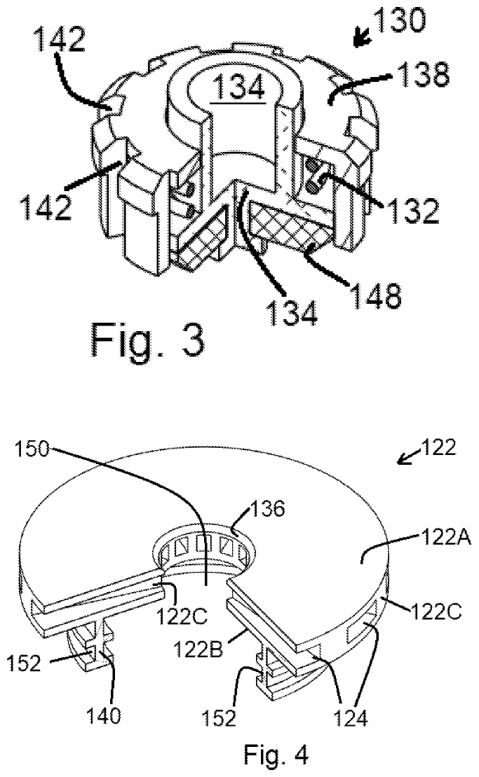

The inlet opening of the at least one radial crossflow channel 124 is arranged at the radially outer side of the end plate 122 and is in fluid communication with the unfiltered fluid to be filtered at the radial outer side of the filter element 102. The outlet opening of the at least one radial crossflow channel 124 is arranged at the radially inner side of the end plate proximate to and facing the central flow opening 150 of the end plate 122. As can be understood from FIG. 2, the central flow opening 150 may, in some embodiments of the invention, be configured to extend through only one of the lower plate 122B or the upper plate 122A, such that the remaining plate can be closed and not have a central opening. As shown in FIG. 2, the central flow opening 150 is in the upper plate 122A and provides fluid communication between the radially inner side crossflow channels 124 and the substantially open interior of the filter element 102, through the bypass valve 130. In preferred aspects, as will be discussed and as shown, the central flow opening 150 extends through both the lower plate 122B and the upper plate 122A, as shown in FIG. 3, for an example, when the inflow side and the outflow side of the filter element 102 are separated in the filter housing 106 by the presence of an annular drain plug member (140, FIG. 2) on the end plate 122 which seals into a drain opening depression 144 of the filter housing 106. An advantage of this configuration is that, when removing the filter element 102 from the filter housing 106 the end plate 122, the central flow opening 150 though both the upper plate 122A and the lower plate 122B very importantly permits fluid to drain from the substantially open interior of the filter element 102, through the central flow opening 150 to exit the filter housing 106 though the drain opening 114 of the filter housing without spilling fluid to the environment. So, in general, it is preferred and critical for a maximum filter element fluid drainage from the filter element for the central flow opening 150 to extend completely through the end plate 122, through both the upper plate 122A and the lower plate 122B. In general, this is the preferred configuration for drainage reasons, where the housing the end plate configurations permit this (for example as in FIG. 2).

FIG. 3 depicts an enlarged quarter section perspective view showing inventive internal details of the bypass valve shown in FIG. 2, consistent with the present inventive disclosure. As shown in FIGS. 2 and 3, the filter element may include a bypass valve assembly arranged in the substantially open interior of the filter element and responsive to changes in fluid pressure drop through the annular filter medium to open or close off bypass flow from the at least one radial crossflow channel of the end plate, the bypass valve assembly having a valve body 134 arranged to move axially from a first position where the valve body 134 closes off the central flow opening 150 of the end plate 122, to a second position where the valve body 134 moves away from the central flow opening 150, thereby enabling bypass fluid to flow from the end plate radial cross flow channels 124 and enter the substantially open interior of the filter element 102. The bypass valve assembly includes a valve housing 138 in which the valve body 134 is arranged to move axially, and a valve spring 132 which acts against the valve housing 138 and the valve body 134, the valve spring 132 applying a closing force onto the valve body 134 to hold the valve body in the first position closing against the valve seat 136. When the fluid pressure drop of the filter element 102 exceeds a predefined limit, the spring closing force is overcome and the valve body moves under the force of fluid pressure to the second position, away from the valve seat 136 such that fluid flow from the at least one radial crossflow channel 124 of the end plate 122 flows through the bypass valve assembly 130 to enter the filtered side of the filter element 102 at the substantially open interior, thereby reducing pressure drop through the filter element 102 and maintaining fluid flow.

As shown in FIG. 3, the valve seat may be formed by the end plate 122, the valve seat formed about an outer circumference of the central flow opening 150. As shown in FIG. 3, the valve seat is preferably conical or tapered to provide a larger sealing area to seal against the valve body 134 to more effectively close off the central flow opening 150 when in the first position.

As shown in FIG. 3, the valve body 134 or the valve seat 136 may beneficially include a valve body elastomer seal 148 configured to fluidically seal the valve body 134 against the valve seat 136 when in the first position.

As shown in FIGS. 3 and 2, the valve housing 138 includes at least one axially extending groove 142 formed into a radially outer side of the valve housing 138. The at least one axially extending groove 142 forming a portion of a fluid flow path for the bypass fluid to flow from the at least one end plate radial crossflow channel 124 and then enter the substantially open interior of the filter element 102. As shown in FIG. 3, a portion of the at least one axially extending groove 142 in the valve housing 138 may open through the wall of the valve housing 138 and into the substantially open interior of the valve housing 138, permitting bypass fluid to flow from the valve body (when in position 2), through the at least one axially extending groove 142 of the valve housing 138 and into the substantially open interior of the valve housing 138.

As shown in FIG. 2, the filter element may further include a drain plug member 140 (preferably annular), formed on and projecting axially outwardly away from an axially outer side of the end plate 122, specifically from an axially outer side of the lower plate 122B. At least one (preferably two) elastomeric seals are arranged on the drain plug member and secured in seal retaining grooves 152 and adapted to seal against and close off the housing drain opening 114 when the filter element 102 is in an installed state in the filter housing 106, and to open the drain opening 114 when the filter element 102 is removed from the installed state, to allow fluid to drain from the filter housing 106 when exchanging the filter element 102.

As shown in FIG. 4, the end plate 122 is preferably formed together at the same time as one piece, as a unitary end plate 122. As shown in FIG. 4, the end plate 122 includes an upper annular plate or wall 122A, a lower annular plate or wall 122B, and a plurality of radially extending crossflow channel separation walls 122C arranged between the upper annular wall 122A and the lower annular wall 122B. The plurality of radially extending crossflow channel separation walls 122C each extending between and connected to at least one of the annular walls (122A, 122B) of the end plate 122. The upper annular wall 122A, the lower annular wall 122B and the plurality of radially extending crossflow channel separation walls 122C cooperate to define and form the at least one radial crossflow channel 124 extending radially within the interior of the end plate 122.

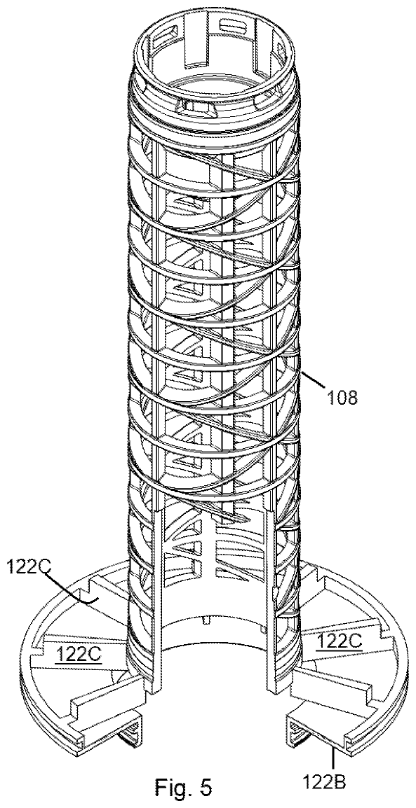

In a variation of FIG. 4 together with FIG. 5, the end plate 122, the upper annular wall 122A and the lower annular wall 122B may be formed as separate components, at least one of the annular walls (122A, 122B) having the radially extending crossflow channel separation walls 122C formed thereon, such that when the end plate 122 is assembly by connecting the upper annular plate or wall 122A to the a lower annular plate or wall 122B, the complete end plate 122 is formed.

As shown in FIG. 5, in some aspects of the invention, the end plate 122 includes a support tube 108 formed together in one piece with the end plate 122, all formed in one piece at a same time as a single unitary component, the support tube 108 having a plurality of flow openings, the support tube arranged in the substantially open interior oof the filter element 102 and positioned to support the annular filter medium 104 at the outflow face 128 against fluid flow forces acting on the filter medium 104. The end plate 122 of FIG. 5 may be abutted against and connected to an upper annular plate or wall as in 122A FIG. 4 to form the complete end plate enclosing the radially extending crossflow channel separation walls 122C.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A filter element for filtering a gaseous or liquid fluid, comprising:
an annular filter medium, surrounding a substantially open interior defining a longitudinal axis of the filter element, the annular filter medium having:
an inflow face at a radially outer side of the annular filter medium receiving unfiltered fluid to be filtered;
an outflow face at a radially inner side of the annular filter medium discharging filter fluid, the outflow face surrounding the substantially open interior;
an end plate arranged on and covering a first axial end filter element;
wherein the end plate includes:
a central flow opening extending axially through the first end plate and opening into the substantially open interior;
at least one radial crossflow channel extending radially through an interior of the end plate from a radially outer side of the end plate and opening into the central flow opening of the end plate, the at least one crossflow channel configured to bypass fluid flow through the end plate, bypassing the annular filter medium,
wherein an inlet opening of the at least one radial crossflow channel is arranged at the radially outer side of the end plate and is in fluid communication with the unfiltered fluid to be filtered,
wherein an outlet opening of the at least one radial crossflow channel is arranged at the radially inner side of the end plate proximate to the central flow opening.

2. The filter element according to claim 1, further comprising:
a bypass valve assembly arranged in the substantially open interior of the filter element and responsive to changes in fluid pressure drop through the annular filter medium to open or close off bypass flow from the at least one radial crossflow channel of the end plate, the bypass valve assembly comprising:
a valve body arranged to move axially from a first position where the valve body closes off the central flow opening of the end plate, to a second position where the valve body move away from the central flow opening, enabling bypass fluid to flow from the end plate radial cross flow channels and enter the substantially open interior;
a valve housing;
a valve spring acting against the valve housing and the valve body, applying a closing force on the valve body acting to hold the valve body in the 40 first position, wherein when the fluid pressure drop exceeds a predefined limit, the closing force of the valve spring is overcome by fluid forces and the valve body move freely to the second position.

3. The filter element according to claim 2, wherein
a valve seat is formed by the end plate about an outer circumference of the central flow opening, the valve body closing against the valve seat when in the first position.

4. The filter element according to claim 3, wherein
at least one of the valve body or the valve seat includes an elastomeric seal arranged to seal the valve body against the valve seat when the first position, thereby closing off flow through the central opening of the end plate.

5. The filter element according to claim 3, wherein
the valve housing includes at least one axially extending groove formed in a radially outer side of the valve housing, the at least one axially extending groove forming a portion of a fluid flow path for bypass fluid to flow from the end plate radial cross flow channels and enter the substantially open interior.

6. The filter element according to claim 1, further comprising:
a drain plug member, formed on and projecting axially outwardly away from an axially outer side of the end plate;
at least one elastomeric seal arranged on the drain plug member and adapted to seal against and close off a housing drain opening when the filter element is installed state in a filter housing, and to open the dra.in opening when the filter element is removed from the installed state.

7. The filter element according to claim 1, wherein
the end plate comprises:
an upper annular wall;
a lower annular wall;
a plurality of radially extending bypass channel separation walls arranged between the upper annular wall and the lower annular wall, the plurality of radially extending bypass channel separation walls each connected to at least one of the annular walls of the end plate;
wherein the upper annular wall, the lower annular wall and the plurality of radially extending bypass channel separation walls cooperate to define and form the at least one radial crossflow channel;
wherein the upper annular wall and the lower annular wall are assembled together to form the end plate.

8. The filter element according to claim 1, wherein
the end plate further comprises:
a support tube formed together with the end plate in one piece at a same time as a single unitary component, the support tube having a plurality of flow openings, the support tube arranged in the substantially open interior and configured to support the annular filter medium at the outflow face.

9. The filter element according to claim 1, wherein
the end plate is completely formed in one piece at a same time as a single unitary component.

10. A filter system for filtering a gaseous or liquid fluid, comprising:
a filter housing having an interior chamber;
a filter element according to claim 1, installed into the interior chamber of the filter housing,
wherein unfiltered gaseous or liquid fluid enters the filter element at the inflow face at a radially outer side of the annular filter medium,
wherein filtered gaseous or liquid fluid exits the filter element at the outflow face at the at a radially inner side of the annular filter medium, and into the substantially open interior;
wherein the at least one radial crossflow channel of the end plate forms at least a portion of a flow path operable for bypassing the gaseous or liquid fluid around the filter medium of the filter element;
wherein the inlet opening of the at least one radial crossflow channel at the radially outer side of the end plate is in fluid communication with the gaseous or liquid fluid to be filtered;
wherein the outlet opening of the at least one radial crossflow channel at the radially inner side of the end plate is arranged facing towards the central flow opening.

11. The filter system according to claim 10, further comprising:
a bypass valve assembly arranged in the substantially open interior of the filter element and responsive to changes in fluid pressure drop through the annular filter medium to open or close off bypass flow from the at least one radial crossflow channel of the end plate, the bypass valve comprising:
a valve body arranged to move axially from a first position where the valve body closes off the central flow opening of the end plate, to a second position where the valve body move away from the central flow opening, enabling bypass fluid to flow from the end plate radial cross flow channels, through the bypass valve assembly and enter the substantially open interior;
a valve housing;
a valve spring acting against the valve housing, applying a closing force on the valve body to hold the valve body in the first position, wherein when the fluid pressure drop exceeds a predefined limit, the closing force is overcome and the valve body is free to move to the second position.

12. The filter system according to claim 11, wherein
a valve seat is formed by the end plate about an outer circumference of the central flow opening, the valve body closing against the valve seat when in the first position.

13. The filter system according to claim 12, wherein
at least one of the valve body and the valve seat includes an elastomeric seal arranged to seal valve body against the valve seat when the first position.

14. The filter system according to claim 13, wherein
the valve housing includes at least one axially extending groove formed in a radially outer side of the valve housing, the at least one axially extending groove forming a fluid flow path fluid to flow from the end plate radial cross flow channels, then around the outer side of the valve housing and enter the substantially open interior.

15. The filter system according to claim 10, wherein
the filter housing further includes:
a housing drain opening formed as a depression in a bottom wall of the filter housing;
wherein the filter element further includes:
a drain plug member, formed on and projecting axially outwardly away from an axially outer side of the end plate;
at least one elastomeric seal arranged on the drain plug member and adapted to seal against walls of the housing drain opening depression and close off a housing drain opening when the filter element is installed state in a filter housing, and to open the drain opening when the filter element is removed from the installed state.

16. The filter system according to claim 15, wherein
the drain opening depression is an annular groove formed in the bottom wall of the filter housing and surrounding the longitudinal axis.

17. The filter system according to claim 10, wherein
the end plate further comprises:
a support tube formed together with the end plate as one piece at a same time as a single unitary component, the support tube having a plurality of flow openings, the support tube arranged in the substantially open interior and configured to support the annular filter medium at the outflow face.

18. The filter system according to claim 10, wherein
the end plate comprises:
an upper annular wall;
a lower annular wall;
a plurality of radially extending bypass channel separation walls arranged between the upper annular wall and the lower annular wall, the plurality of radially extending bypass channel separation walls each connected to at least one of the annular walls of the end plate;
wherein the upper annular wall, the lower annular wall and the plurality of radially extending bypass channel separation walls cooperate to define and form the at least one radial crossflow channel entending radially through an interior of the end plate;
wherein the upper annular wall and the lower annular wall are assembled together to form the end plate.

19. The filter system according to claim 10, wherein
the end plate further comprises:
a support tube formed together with the end plate in one piece at a same time as a single unitary component, the support tube having a plurality of flow openings, the support tube arranged in the substantially open interior and configured to support the annular filter medium at the outflow face.

20. The filter system according to claim 10, wherein
the end plate is completely formed together in one piece at a same time as a single unitary component.
